(19) United States
(12) Patent Application Publication
(10) Pub. No.: US 2015/0062983 A1
(43) Pub. Date: Mar. 5, 2015

(54) CHOKE COIL AND POWER SUPPLY DEVICE INCLUDING THE SAME

(71) Applicant: SAMSUNG ELECTRO-MECHANICS CO., LTD., Suwon (KR)

(72) Inventors: Hwa Hun CHIN, Suwon (KR); Jae Sun WON, Suwono (KR); Myung Chul LEE, Suwon (KR); Seung Ho HAN, Suwon (KR); Tae Hoon KIM, Suwon (KR); Seung Wan YU, Suwon (KR)

(73) Assignee: SAMSUNG ELECTRO-MECHANICS CO., LTD., Suwon (KR)

(21) Appl. No.: 14/168,874

(22) Filed: Jan. 30, 2014

(30) Foreign Application Priority Data
Aug. 30, 2013 (KR) 10-2013-0104098

(51) Int. Cl. H01F 27/28; H02M 1/44

(52) U.S. Cl. CPC H01F 27/28; H02M 1/44
USPC 363/44; 336/220

(57) ABSTRACT

There is provided a choke coil, including: a core part having first and second legs; a winding part having a first coil wound around the first leg and a second coil wound around the second leg; and a sectioning wall partitioning the winding part into several winding regions.

### CROSS-REFERENCE TO RELATED APPLICATION

This application claims the benefit of Korean Patent Application No. 10-2013-0104098 filed on Aug. 30, 2013, with the Korean Intellectual Property Office, the disclosure of which is incorporated herein by reference.

### BACKGROUND

The present disclosure relates to a choke coil with reduced parasitic capacitance and a power supply device including the same.

Recently, in the field of flat panel displays (FPDs) such as liquid crystal displays (LCDs), plasma display panels (PDPs), organic light emitting diodes (OLEDs), such products have become smaller and slimmer, and processing speeds thereof have increased. Under these circumstances, noise from electromagnetic waves may cause various problems in such devices.

Traditionally, display devices, printers, and other electric/electronic devices employ switching mode power supplies (SMPSs) for supplying power thereto.

A SMPS is a modular power supply device that converts externally supplied electricity into electricity usable in various types of electric/electronic devices such as a computer, a TV, a wireless communication device and the like. It serves to convert household power into high efficiency/high quality power as required by various electronic devices by way of using the switching of semiconductor devices and a power conversion function of a transformer.

In operation, however, a SMPS is accompanied by various noise caused by electromagnetic interference (EMI) generated when switching operation is made.

In particular, a flat panel display may have a relatively large amount of electromagnetic noise generated therein by a power converter, an image board, a semiconductor device and the like, which operate in a switching manner, and thus various types of EMI filter are used therein to suppress electromagnetic wave noise.

Electromagnetic wave noise may be largely classified into conducted emissions (CE) and radiated emissions (RE), each of which may be further classified into differential-mode noise and common-mode noise. An EMI filter to reduce differential-mode noise commonly uses a normal-mode choke and an X-capacitor, while an EMI filter to reduce common-mode noise commonly uses a common-mode choke and a Y-capacitor.

In particular, as the operating speeds of SMPSs are increased, EMI noise in a high frequency band (approximately 1 MHz or higher) may occur excessively, and a common-mode choke coil for high frequencies is typically used for attenuating noise in the high-frequency band.

A typical toroidal type common-mode choke has high parasitic capacitance so that resonant frequency distribution is low. Accordingly, separate common-mode chokes are required in a high-frequency band and a low-frequency band. This is disadvantageous in terms of configuring a simple EMI circuit. Moreover, this requires manual intervention so that productivity is lowered and product quality may not be maintained.

### RELATED ART DOCUMENTS

(Patent Document 1) Korean Patent Laid-Open Publication No. 2006-0071170

(Patent Document 2) Japanese Patent Laid-open Publication No. 1994-325945

### SUMMARY

An aspect of the present disclosure may provide a choke coil with reduced parasitic capacitance.

An aspect of the present disclosure may also provide a choke coil that may be automatically wound and thus may increase production yield and save manufacturing costs.

An aspect of the present disclosure may also provide an EMI filter that has a high resonant frequency so as to be applied in both high- and low-frequency bands.

According to an aspect of the present disclosure, a choke coil may include: a core part having first and second legs; a winding part having a first coil wound around the first leg and a second coil wound around the second leg; and a sectioning wall partitioning the winding part into several winding regions.

The winding part may have at least one of the first coil and the second coil wound in a first axial direction perpendicular to the first leg and the second leg.

The winding part may have at least one of the first coil and the second coil wound in a second axial direction parallel to the first leg and the second leg.

A first turns amount that at least one of the first coil and the second coil is wound at in the first axial direction in the first winding region may be different from a second turns amount that at least one of the first coil and the second coil is wound at in the first axial direction in the second winding region.

A first turns amount that at least one of the first coil and the second coil is wound at in the second axial direction in the first winding region may be different from a second turns amount that at least one of the first coil and the second coil is wound at in the second axial direction in the second winding region.

The sectioning wall may include: a first sectioning wall partitioning a region in which the first coil is wound into several regions, and a second sectioning wall partitioning a region in which the second coil is wound into several regions.

The first coil wound in the first winding region and the first coil wound in the second winding region may be contiguous through the first sectioning wall, and the second coil wound in the first winding region and the second coil wound in the second winding region may be contiguous through the second sectioning wall.

A length of the first winding region in the second axial direction may be different from a length of the second winding region in the second axial direction.

According to another aspect of the present disclosure, a power supply device may include: a power input unit supplying input power; an EMI filter unit removing noise from the input power; and a converter unit converting power supplied from the EMI filter unit, wherein the EMI filter unit includes: a core part having first and second legs; a winding part having a first coil wound around the first leg and a second coil wound around the second leg; and a sectioning wall partitioning the winding part into several winding regions.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram of a flat panel display;

FIG. 2 is a circuit diagram of a typical EMI filter;

FIG. 3A through 3C are views showing a typical common-mode choke coil;

FIGS. 4A through 4C are views showing parasitic capacitance in the common-mode choke coils shown in FIG. 3;

FIG. 5A through 5C are views showing a common-mode choke coil according to an exemplary embodiment of the present disclosure;

FIGS. 6A through 6C are views showing parasitic capacitance in the common-mode choke coil shown in FIG. 5;

FIGS. 7A and 7B are views showing coils wound according to other exemplary embodiments of the present disclosure;

FIGS. 8A and 8B are views showing coils wound according to other exemplary embodiments of the present disclosure;

FIG. 9 is a graph showing impedance characteristics of a choke coil with an unpartitioned region and impedance characteristics of a choke coil with partitioned winding regions;

FIG. 10 is a circuit diagram in which the choke coil according to an exemplary embodiment of the present disclosure is employed as an EMI filter;

FIG. 11 is a graph showing results of measuring EMI from an EMI filter according to the related art; and

FIG. 12 is a graph showing results of measuring EMI from an EMI filter employing the choke coil according to an exemplary embodiment of the present disclosure.

### DETAILED DESCRIPTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

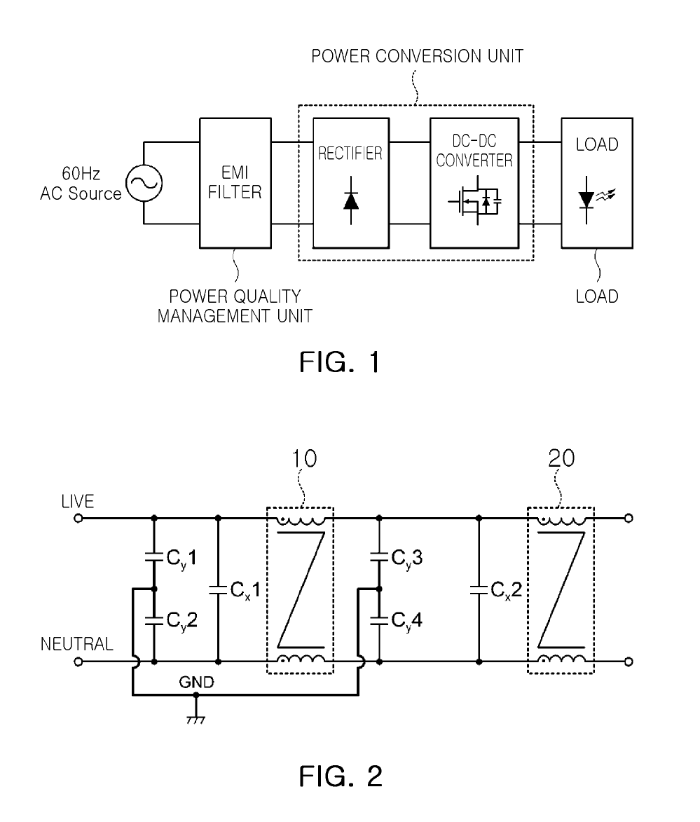

FIG. 1 is a block diagram of a flat panel display.

Referring to FIG. 1, the flat panel display may include a power quality management unit, a power conversion unit, and a load.

The load may include a light-emitting diode.

The power conversion unit may include a rectification stage, a phase compensation unit, and a switched-mode DC/DC converter. The switched-mode DC/DC converter may include a flyback converter, for example, and may employ various isolated converter topologies.

A significant amount of electromagnetic interference (EMI) may occur, since abrupt changes in current and voltage occur in a DC/DC converter, and image modes and semiconductor devices are manufactured to be smaller and faster.

In order to suppress EMI, an EMI filter may be disposed before a rectifier.

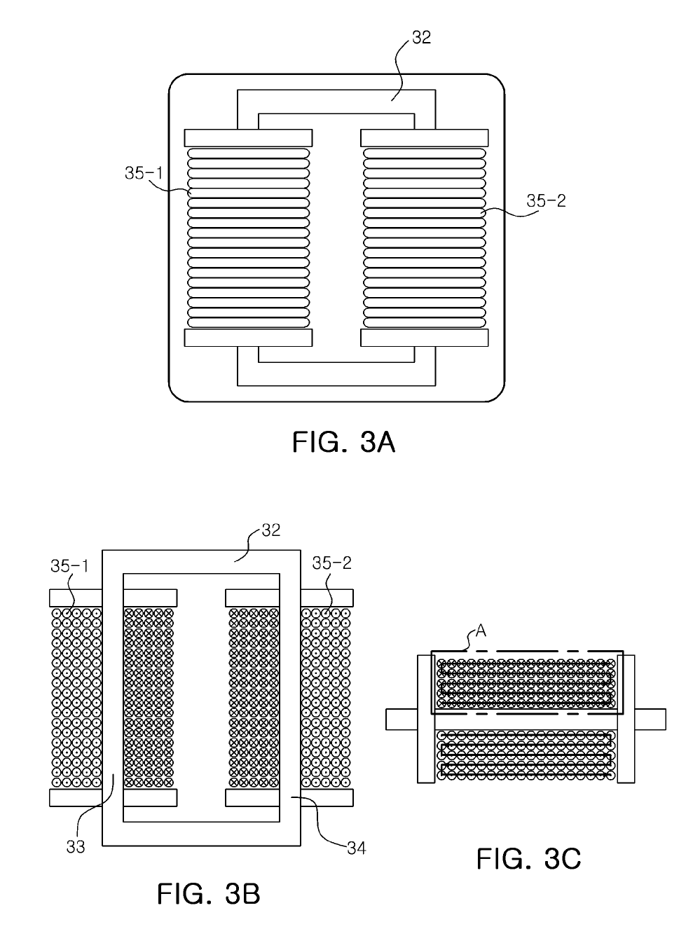

FIG. 2 shows a typical EMI filter.

Referring to FIG. 2, the EMI filter may include a CM choke for low frequencies 10 and a CM choke for high frequencies so as to attenuate noise in low-frequency band and high-frequency band, respectively.

The EMI filter requires two magnetic elements, so that the unit price and volume are increased.

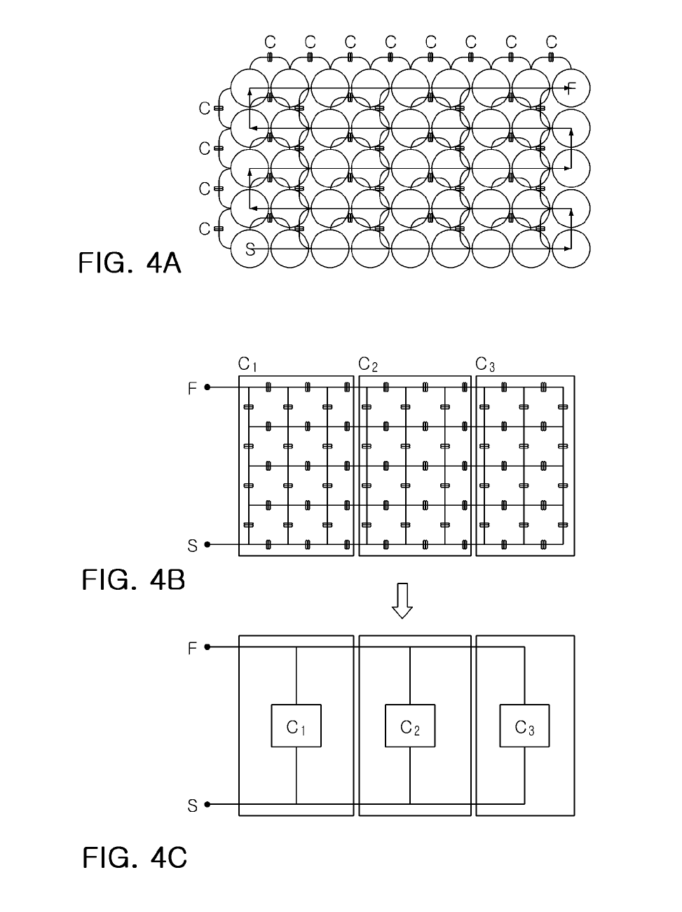

FIGS. 3A through 3C show a typical common-mode choke coil.

Referring to FIG. 3A, the common-mode choke coil may include a core part 32 and a winding part 35.

FIG. 3B is a cross-sectional view of the common-mode choke coil shown in FIG. 3A.

The core part 32 may include a first leg 33 and a second leg 34. Around the first leg 33 and the second leg 34, coils are wound.

The winding part 35 may include a first coil 35-1 and a second coil 35-2.

FIG. 3C shows a winding order in which the first coil 35-1 is wound around the first leg 33 of the common-mode choke coil.

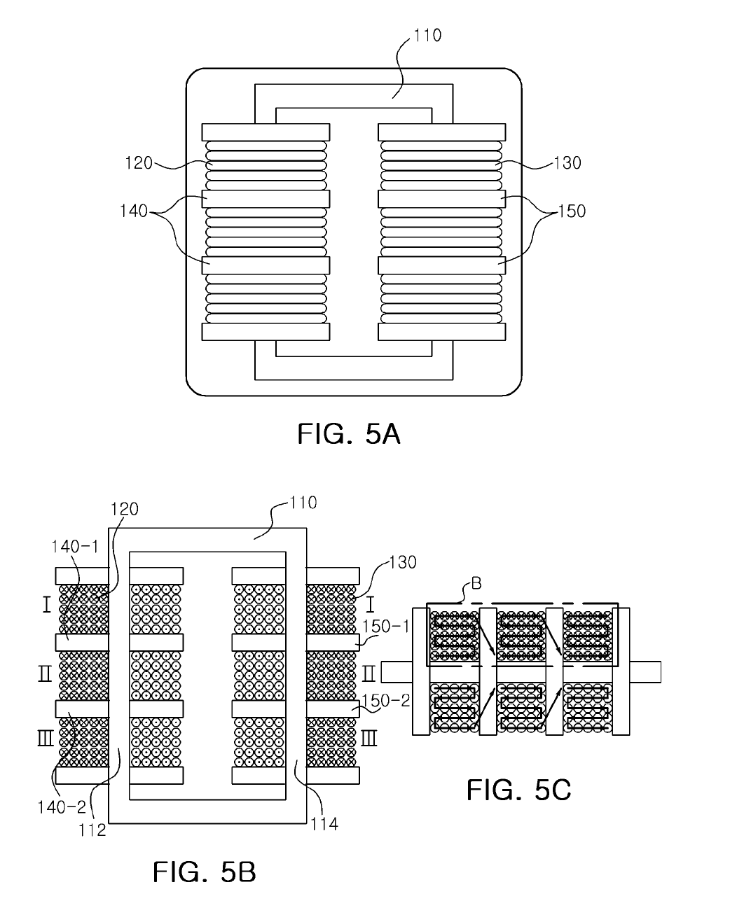

FIGS. 4A through 4C show parasitic capacitance in the common-mode choke coils shown in FIG. 3.

FIG. 4A is an enlarged view of portion A of FIG. 3C.

As shown in FIG. 4A, there exists parasitic capacitance C between adjacent coils.

FIG. 4B is a view in which the parasitic capacitance in portion A of FIG. 3C is modeled.

Here, the values of parasitic capacitance may be represented by modeling it for each of regions.

FIG. 4C shows coupled parasitic capacitance modeled in each of the regions.

As shown in FIG. 4C, the parasitic capacitances C1, C2 and C3 in the respective regions are connected in parallel, and the parasitic capacitance in each of the regions may be calculated as follows:

Cₜₒₜₐₗ=C₁+C₂+C₃ [Mathematical Expression 1]

As can be seen from Mathematical Expression 1, as the turns amount of the wound coils increases, the parasitic capacitance generated in parallel increases, and thus the total parasitic capacitance also increases.

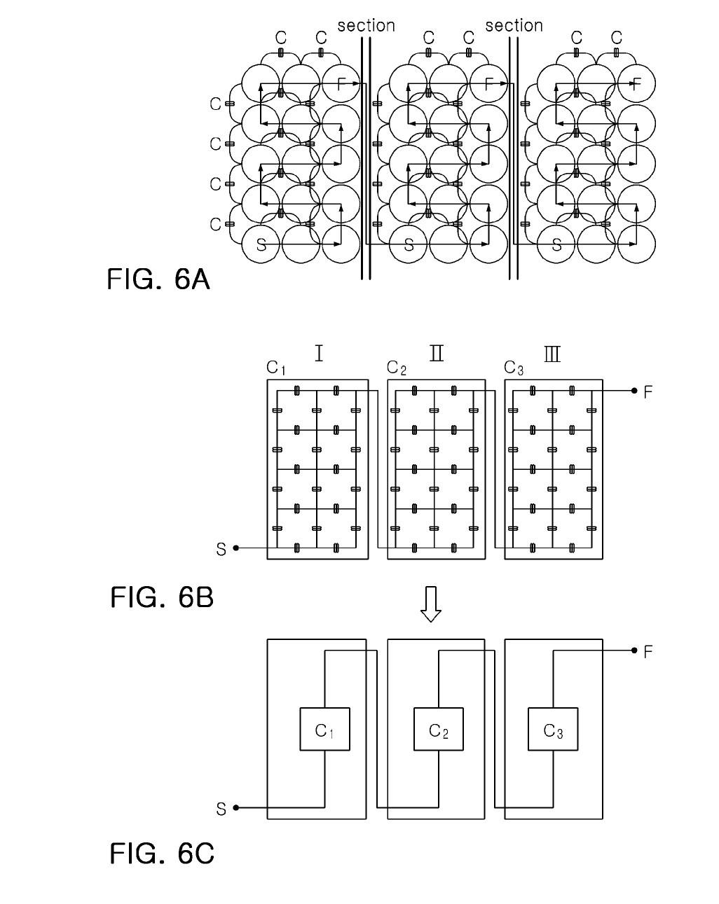

FIG. 5 is a diagram showing a common-mode choke coil according to an exemplary embodiment of the present disclosure.

Referring to FIG. 5A, the common-mode choke coil may include a core part 110, winding parts 120 and 130, and sectioning walls 140 and 150.

FIG. 5B is a cross-sectional view of the common-mode choke coil shown in FIG. 5A.

The core part 110 may include a first leg 112 and a second leg 114. Around the first leg 112 and the second leg 114, coils are wound. Here, the leg around which a first coil 120 is wound is defined as a first leg 112, and the leg around which a second coil 130 is wound is defined as a second leg 114.

The winding part 120 may include the first coil 120 and the second coil 130.

As shown in FIG. 5, the first coil 120 may be wound in a first axial direction. Here, the first axial direction refers to a direction perpendicular to the first and second legs 112 and 114.

Further, the second coil 130 may be wound in the first axial direction.

As shown in FIG. 5, the first coil 120 may be wound in a second axial direction. Here, the second axial direction refers to a direction parallel to the first and second legs 112 and 114.

Further, the second coil 130 may be wound in the second axial direction.

The sectioning walls may section the winding part into several winding regions.

Specifically, a first sectioning wall 140 may section the region in which the first coil 120 is wound into several winding regions.

Referring to FIG. 5B, the first sectioning wall 140 may section the region in which the first coil 120 is wound into three winding regions I, II, and III.

For example, by two first sectioning walls 140-1 and 140-2, the region in which the first coil 120 is wound may be partitioned into three winding regions (a first winding region I, a second winding region II, and a third winding region III).

Although the region is partitioned into the winding regions I, II, and III, the first coil 120 may be contiguous through the first sectioning walls 140-1 and 140-2.

Specifically, a second sectioning wall 150 may section the region in which the second coil 130 is wound into several winding regions.

Referring to FIG. 5B, the second sectioning wall 150 may section the region in which the second coil 130 is wound into three winding regions I, II, and III.

For example, by virtue of two second sectioning walls 150-1 and 150-2, the region in which the second coil 130 is wound may be partitioned into three winding regions (a first winding region I, a second winding region II, and a third winding region III).

Although the region is partitioned into the winding regions I, II, and III, the second coil 130 may be contiguous through the second sectioning walls 150-1 and 150-2.

FIG. 5C shows a winding order in which the first coil 120 is wound around the first leg 112 of the common-mode choke coil.

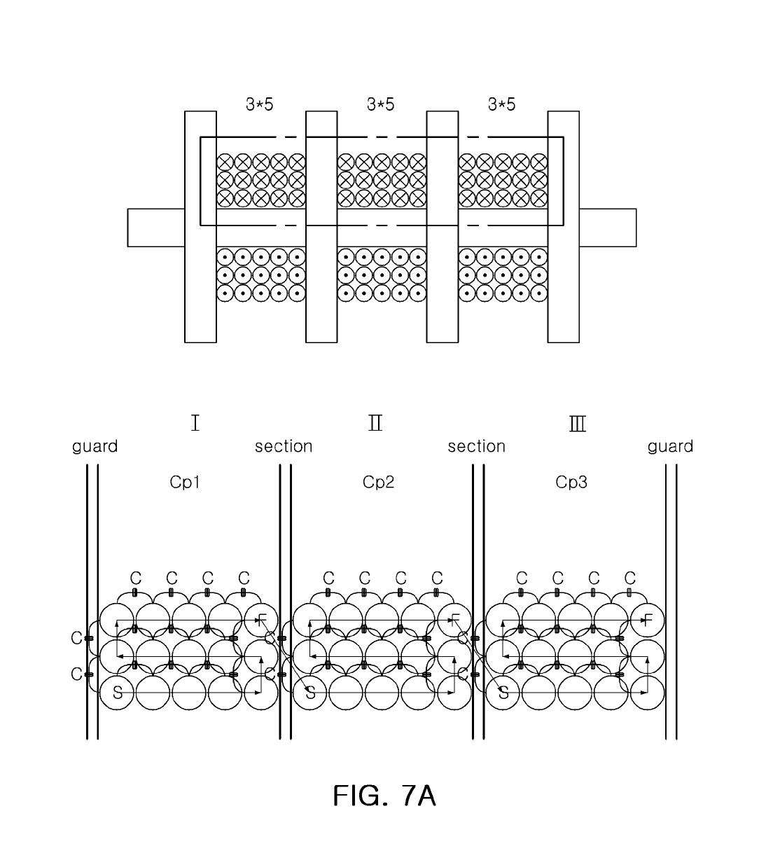

FIGS. 6A through 6C show parasitic capacitance in the common-mode choke coil shown in FIG. 5.

FIG. 6A is an enlarged view of portion B of FIG. 5C.

As shown in FIG. 6A, parasitic capacitance C exists between adjacent coils.

It is to be noted that only the end portion of the coil wound in the first winding region I and the end portion of the coil wound in the second winding region II are connected to each other but the other portions of the coil wound in the first winding region I and of the coil wound in the second winding region II are separated by the first sectioning wall.

FIG. 6B is a view in which the parasitic capacitance in portion B of FIG. 5C is modeled.

Here, the values of parasitic capacitance may be represented by being modeled for each of the regions.

As shown in FIG. 6B, the parasitic capacitance in the first winding region I and the parasitic capacitance in the second winding region II are connected in series. Further, the parasitic capacitance in the second winding region II and the parasitic capacitance in the third winding region III are connected in series.

FIG. 6C shows coupled parasitic capacitance modeled in each of the regions.

As shown in FIG. 6C, the parasitic capacitances C1, C2 and C3 in the respective regions are connected in series, and the parasitic capacitance in the regions may be calculated as follows:

1/Cₜₒₜₐₗ=1/C₁+1/C₂+1/C₃ [Mathematical Expression 2]

As can be seen from Mathematical Expression 2, as the number of winding regions separated by the sectioning walls increases, the parasitic capacitance generated in series increases, and thus the total amount of parasitic capacitance may be decreased.

That is, the choke coil according to an exemplary embodiment of the present disclosure may reduce stray capacitance between coils. Accordingly, the first resonant frequency may move to a high-frequency band in an impedance graph of the common-mode choke. Therefore, the common-mode choke according to an exemplary embodiment of the present disclosure may widen the bandwidth of impedance so that EMI noise after the first resonant band may be effectively removed.

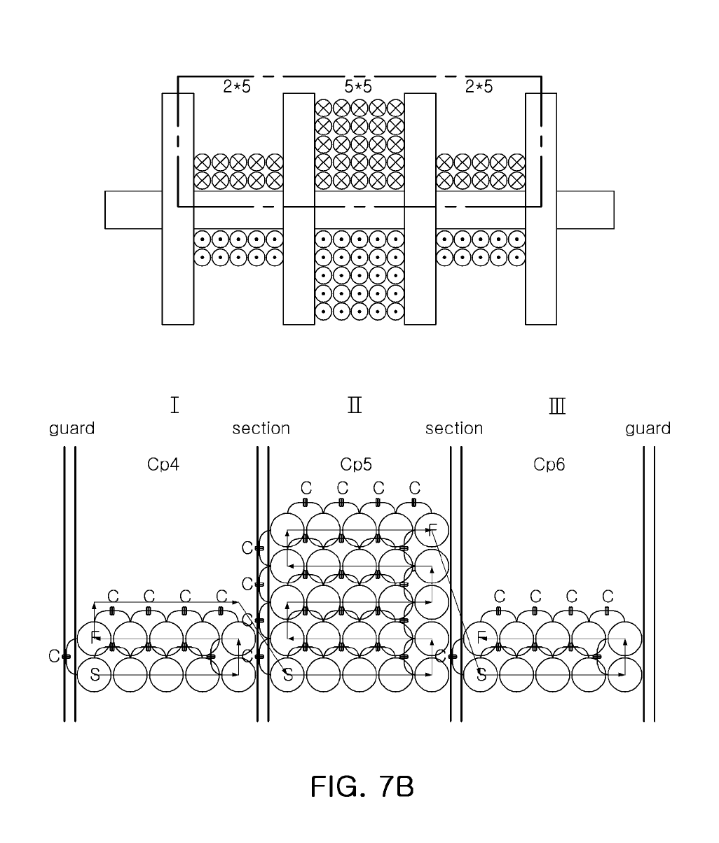

FIG. 7 shows a method of winding a coil according to another exemplary embodiment of the present disclosure.

As can be seen from Mathematical Expression 2, the value of the total capacitance Cₜₒₜₐₗ is smaller than the smallest parasitic capacitance among the parasitic capacitances generating in the winding regions.

Here, the total parasitic capacitance may be less than the parasitic capacitance of a winding region even if the levels of parasitic capacitance in other winding regions are very high, by way of designing the parasitic capacitance of the winding region to be low.

FIG. 7A shows the parasitic capacitance of an evenly wound coil.

In FIG. 7B, the parasitic capacitance may be calculated as follows:

1/C_{Ptotal1}=1/Cₚ₁+1/Cₚ₂+1/Cₚ₃ [Mathematical Expression 3]

FIG. 7B shows the parasitic capacitance of an unevenly wound coil.

Referring to FIG. 7B, a first turns amount that a coil is wound in the first axial direction in the first winding region may be different from a second turns amount that the coil is wound in the first axial direction in the second winding region. For instance, the second turns amount may be larger than the first turns amount.

In FIG. 7B, the parasitic capacitance may be calculated as follows:

1/C_{Ptotal2}=1/Cₚ₄+1/Cₚ₅+1/Cₚ₆ [Mathematical Expression 4]

Because the total parasitic capacitance is smaller than the parasitic capacitance in the first winding region or the third winding region in which the coil is unevenly wound, the method of winding shown in FIG. 7B may further reduce the parasitic capacitance compared to the method of winding shown in FIG. 7A.

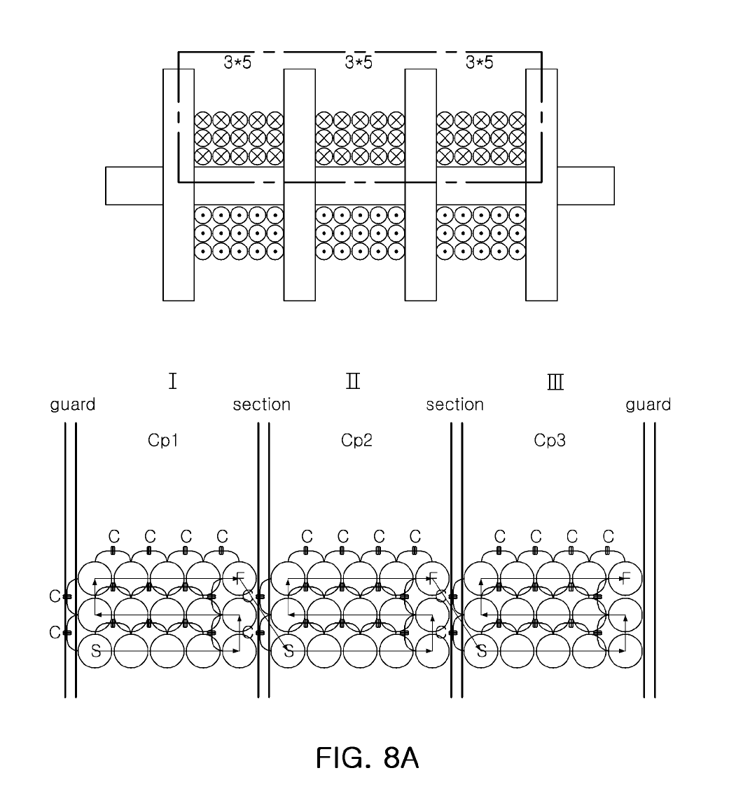

FIG. 8 shows a method of winding a coil according to another exemplary embodiment of the present disclosure.

FIG. 8A shows the parasitic capacitance of an evenly wound coil.

In FIG. 8B, the parasitic capacitance may be calculated as follows:

1/C_{Ptotal1}=1/Cₚ₁+1/Cₚ₂+1/Cₚ₃ [Mathematical Expression 5]

FIG. 8B shows the parasitic capacitance of an unevenly wound coil.

Referring to FIG. 8B, a first turns amount that a coil is wound in the second axial direction in the first winding region may be different from a second turns amount that the coil is wound in the second axial direction in the second winding region. For instance, the second turns amount may be larger than the first turns amount.

In FIG. 8B, the parasitic capacitance may be calculated as follows:

1/C_{Ptotal2}=1/Cₚ₄+1/Cₚ₅+1/Cₚ₆ [Mathematical Expression 6]

Because the total parasitic capacitance is lower than the parasitic capacitance in the first winding region or the third winding region in which the coil is unevenly wound, the method of winding shown in FIG. 8B may further reduce the parasitic capacitance compared to the method of winding shown in FIG. 8A.

Here, the length of the first winding region in the second axial direction may be different from the length of the second winding region in the second axial direction. Further, the length of the second winding region in the second axial direction may be longer than the length of the first winding region in the second axial direction.

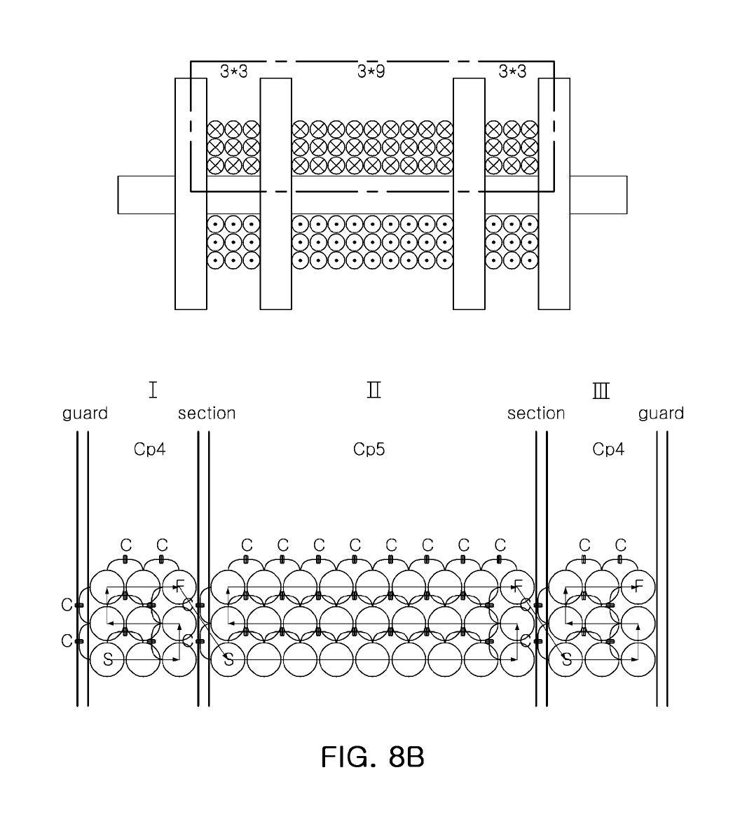

FIG. 9 is a graph showing the impedance characteristic of a choke coil with unpartitioned region and the impedance characteristic of a choke coil with partitioned winding regions.

As can be seen from FIG. 9, and the impedance characteristics of the choke coil with partitioned winding regions according to an exemplary embodiment of the present disclosure are improved.

Table 1 shows parasitic inductance Lm, leakage inductance Lk, and parasitic capacitance Cp according to winding region sections.

TABLE 1

| | Non- | Winding Region | Winding Region |
|---|---|---|---|
| | Partitioned | Partitioned | Partitioned |
| | Winding | Into Three | Into Four |
| Winding Regions | Region | Regions | Regions |
| Lm (mH)) | 17.60/17.50 | 19.75/19.78 | 18.6/18.9 |
| Lk (uH) | 208.01/208.07 | 220.54/220.68 | 215/215 |
| Cp (pF) | 30.7/30.4 | 4.72/4.72 | 2.85/2.89 |

The parasitic capacitances generated according to winding region section are a major factor in determining the first resonant frequency of a common-mode choke based on the mathematical expression below:

$$f = \frac{1}{2 π \sqrt{LC}} \qquad [ Mathematical Expression 7 ]$$

The impedance in a high-frequency band relies heavily on the location of the first resonant frequency and high frequency characteristics may be improved based thereon. In addition, the characteristic also affects on the CE region (150 kHz˜30 MHz) and the RE region (30 MHz˜200 MHz), so that it advantageously improves EMI and simplifies an EMI circuit.

Therefore, in order to meet the impedance requirement necessary for attenuating noise in a high frequency band, parasitic capacitance may be adjusted using an appropriate winding manner, such that a common-mode choke coil may be provided that is automatically wound and has a plurality of winding regions.

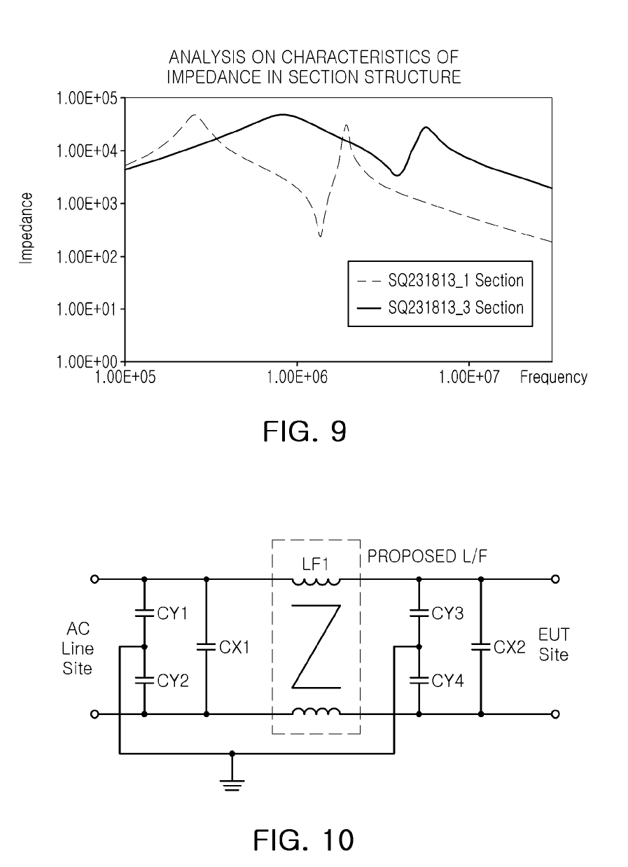

FIG. 10 is a circuit diagram in which the choke coil according to an exemplary embodiment of the present disclosure is employed as an EMI filter.

The choke coil according to the exemplary embodiment reduces parasitic capacitance to thereby improve frequency characteristics. Therefore, when the choke coil according to the exemplary embodiment is employed as an EMI filter, the EMI filter may be configured with a single choke coil, unlike a typical two-stage EMI filter.

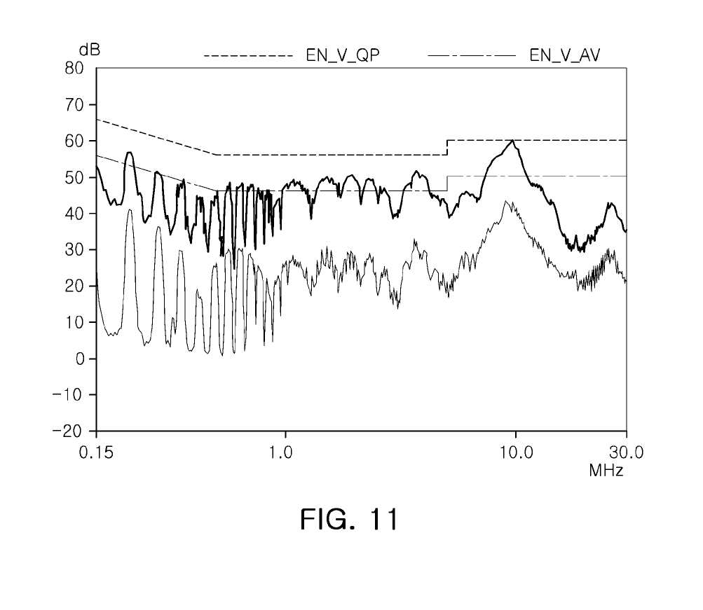

FIG. 11 is a graph showing results of measuring EMI from an EMI filter according to the related art.

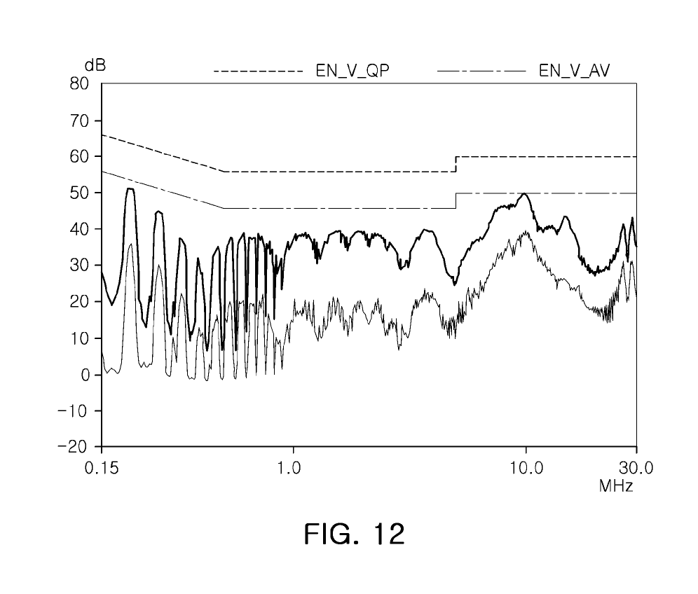

FIG. 12 is a graph showing results of measuring EMI from an EMI filter employing the choke coil according to an exemplary embodiment.

Comparing the EMI characteristics of FIGS. 11 and 12, it can be seen that, in the frequency band from 0.7 MHz to 5 MHz and around 10 MHz, the single-stage filter employing the common-mode choke with reduced parasitic capacitance exhibits batter characteristic than the single-stage EMI filter employing a typical common-mode choke by approximate 10 dB.

By employing the choke coil according to an exemplary embodiment of the present disclosure, a typical two-stage EMI filter may be configured as a single-stage EMI filter. Accordingly, the number of elements at an EMI filter stage may be reduced, and thus costs incurred in manufacturing the EMI filter may be saved.

Further, since the common-mode choke with reduced parasitic capacitance and an EMI filter structure use automatic winding, for a period required for design may be shortened and development costs may be saved. That is, existing automatic equipment may be used without adaptation, and thus no further equipment or costs are required, to thereby save the number of elements and manufacturing cost.

By doing so, the size of an EMI filter may be reduced.

As set forth above, according to exemplary embodiments of the present disclosure, a choke coil with reduced parasitic capacitance may be provided.

Further, a choke coil that is automatically wound and thus increase production yield and saves manufacturing cost may be provided.

Moreover, an EMI filter that has high resonant frequency so as to be applied in both high- and low-frequency bands may be provided.

While exemplary embodiments have been shown and described above, it will be apparent to those skilled in the art that modifications and variations could be made without departing from the spirit and scope of the present disclosure as defined by the appended claims.

What is claimed is:

1. A choke coil, comprising:
a core part having first and second legs;
a winding part having a first coil wound around the first leg and a second coil wound around the second leg; and
a sectioning wall partitioning the winding part into several winding regions.

2. The choke coil of claim 1, wherein the winding part has at least one of the first coil and the second coil wound in a first axial direction perpendicular to the first leg and the second leg.

3. The choke coil of claim 1, wherein the winding part has at least one of the first coil and the second coil wound in a second axial direction parallel to the first leg and the second leg.

4. The choke coil of claim 2, wherein a first turns amount that at least one of the first coil and the second coil is wound at in the first axial direction in the first winding region is different from a second turns amount that at least one of the first coil and the second coil is wound at in the first axial direction in the second winding region.

5. The choke coil of claim 3, wherein a first turns amount that at least one of the first coil and the second coil is wound at in the second axial direction in the first winding region is different from a second turns amount that at least one of the first coil and the second coil is wound at in the second axial direction in the second winding region.

6. The choke coil of claim 1, wherein the sectioning wall includes:
a first sectioning wall partitioning a region in which the first coil is wound into several regions; and
a second sectioning wall partitioning a region in which the second coil is wound into several regions.

7. The choke coil of claim 6, wherein the first coil wound in the first winding region and the first coil wound in the second winding region are contiguous through the first sectioning wall, and the second coil wound in the first winding region and the second coil wound in the second winding region are contiguous through the second sectioning wall.

8. The choke coil of claim 1, wherein a length of the first winding region in the second axial direction is different from a length of the second winding region in the second axial direction.

9. A power supply device, comprising:
a power input unit supplying input power;
an EMI filter unit removing noise from the input power; and
a converter unit converting power supplied from the EMI filter unit, wherein the EMI filter unit includes:
a core part having first and second legs;
a winding part having a first coil wound around the first leg and a second coil wound around the second leg; and
a sectioning wall partitioning the winding part into several winding regions.

10. The power supply device of claim 9, wherein the winding part has at least one of the first coil and the second coil wound in a first axial direction perpendicular to the first leg and the second leg.

11. The power supply device of claim 9, wherein the winding part has at least one of the first coil and the second coil wound in a second axial direction parallel to the first leg and the second leg.
